(19) United States
(12) Patent Application Publication
(10) Pub. No.: US 2020/0009511 A1
(43) Pub. Date: Jan. 9, 2020

(54) THIN FILM COMPOSITE MEMBRANE INCLUDING CROSSLINKED TROGER'S BASE POLYMER

(71) Applicant: DOW GLOBAL TECHNOLOGIES LLC, MIDLAND, MI (US)

(72) Inventors: Praveen Agarwal, Freeport, TX (US); Peter E. M. Aerts, Terneuzen (NL); Tamara Dikic, Terneuzen (NL); Shouren Ge, Freeport, TX (US); Robert E. Hefner, Freeport, TX (US); Yuanqiao Rao, Lake Jackson, PA (US); Bart G. M. Rijksen, Terneuzen (NL); Ian A. Tomlinson, Midland, MI (US)

(21) Appl. No.: 16/494,948

(22) PCT Filed: Mar. 20, 2018
(86) PCT No.: PCT/US18/23216

§ 371 Date: Sep. 17, 2019

Related U.S. Application Data
(60) Provisional application No. 62/482,357, filed on Apr. 6, 2017.

(51) Int. Cl. B01D 69/12; B01D 67/00; B01D 71/62; C08L 65/00; C08K 5/1515; B01D 69/10

(52) U.S. Cl. CPC B01D 69/12; B01D 67/0006; B01D 71/62; C08L 2312/00; C08K 5/1515; B01D 69/10; B01D 2323/30; C08L 65/00

(57) ABSTRACT

A composite membrane including a porous support and a thin film layer comprising a reaction product of: i) a polymer comprising a sub-unit including a Troger's base moiety represented by Formula I:

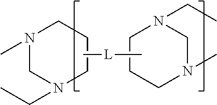

wherein L includes an arylene group substituted with at least one carboxylic acid or a corresponding salt or ester group, or a hydroxyl; and ii) a crosslinking agent selected from at least one of: a) a multifunctional epoxy compound and b) a multifunctional azide compound.

### FIELD

The invention generally relates to thin film composite membranes (“TFC” membranes). Such membranes include a thin discriminating layer located upon a porous support. The invention specifically relates to the use of a polymer having intrinsic microporosity (“PIMs”) as the thin film layer. The subject membranes are generally useful in performing fluid separations and particularly useful in separations involving organic solvents or wide ranges of pH conditions.

### INTRODUCTION

Polymers with intrinsic microporosity (PIMs) are characterized by having macro-molecular structures that are both rigid and contorted so as to have extremely large fractional free volumes. Examples include poly(1-trimethylsilyl-1-propyne) (PTMSP), poly(4-methyl-2-pentyne) (PMP) and polybenzodioxane (PIM-1). Because of their exceptional free volume, all are extremely permeable. See: Baker, Membrane Technology and Applications, 3^{rd} ed., (2012), and Polymers of Intrinsic Microporosity, Enc. Polymer Sci. & Tech., (2009)—both by John Wiley & Sons Ltd. See also: WO2016/206008, WO2016/195977, WO2016/148869, WO2005/113121, US2004/01985587, US2013/0146538, US2013/0172433, US2013/0267616, US2014/0251897, U.S. Pat. Nos. 9,018,270, 8,623,928, 8,575,414, 8,056,732, 7,943,543, 7,690,514 and 7,410,525 which are incorporated herein in their entirety. By way of example, US2014/025 1897 describes a thin film composite membrane including a thin selective layer of a networked microporous polymer having intrinsic microporosity formed via an interfacial polymerization of monomers having concavity (e.g. spirobisindanes, bisnapththalenes, ethanoanthracenes). Similarly, U.S. Pat. No. 9,018,270 describes an interfacial polymerization technique for preparing thin film composite membranes including a thin layer of PIMs. In one embodiment, the polymer includes a repeating unit including a Troger's base moiety, e.g.

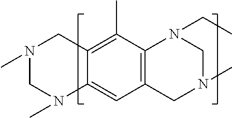

See also D. Xin et al., “Troger's base-functionalized organic nanoporous polymer for heterogeneous catalyst,” Chem. Comm. (2009) pp. 970-972, which provides a description of the preparation of so-called Troger's base nanoporous polymers and their use as catalyst in the addition reaction of diethyl zinc to an aromatic aldehyde.

### SUMMARY

The present invention includes “Troger's base” polymers having intrinsic microporosity and corresponding methods for making the same. The term “Troger's base polymer” refers to polymers including sub-units (and preferably repeating units) having a Troger's base moiety as represented by Formula I. In a preferred embodiment, the invention includes a composite membrane including a porous support and a thin film layer that is a reaction product of: i) a polymer comprising a sub-unit (preferably repeating units) comprising a Troger's base moiety represented by Formula I:

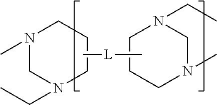

wherein L comprises an arylene group substituted with at least one carboxylic acid or a corresponding salt or ester group, or a hydroxyl; and ii) a crosslinking agent selected from at least one of: a) a multifunctional epoxy compound and b) a multifunctional azide compound. In one set of preferred embodiments, the polymer and crosslinking agent are combined and applied to a porous support from a common solution, or sequentially applied from separate solutions. Thereafter, the polymer is cured such as by way of exposure the radiation (e.g. infrared (e.g. thermal), ultraviolet) or chemical initiators (e.g. peroxides, azo compounds, etc.). In one embodiment, the polymer and crosslinking agent are combined in a common solution and partially reacted to form a B-stage polymer prior to being applied to a porous support and subsequently cured. In preferred embodiments, the polymer and crosslinking agent are water soluble and are applied to the porous support from one or more aqueous solutions. The use of an aqueous based system allows for a broader selection of porous support materials and further reduces environmental and safety issues. The subject covalently crosslinked polymers have superior stability as compared with corresponding ionically crosslinked polymers as described in U.S. Pat. No. 9,018,270.

### DETAILED DESCRIPTION

In a preferred embodiment, the subject polymers (also including copolymers, collectively referred to herein as “polymers”) possess intrinsic microporosity. The term “intrinsic microporosity” refers to a polymer having a continuous network of interconnected intermolecular voids which form as a direct consequence of the shape and rigidity of at least a portion of the component monomers of the polymer. The term “microporous” refers to a material having an interconnected system of voids of a diameter less than 2 nm as defined by the IUPAC. Preferably, the subject polymers have average pore diameters of from 0.2 to 20 nm as determined by standard bubble point test (e.g. ASTM F316-03 (2011)). The copolymers also have high apparent surface areas (e.g. greater than 100 m²/g, and more preferably greater than 150 m²/g as determined by the Brunauer-Emmett-Teller (BET) method. In several embodiments, the subject polymers are partially branched or branched, B-stage copolymers and networked copolymers. Crosslinked polymers of the present invention possess branches that connect polymer chains. The crosslinks typically reduce mobility of the polymer chains and produce a rigid network. Formal definitions for “branch” (1.53), “branch point” (1.54), “branch unit” (1.55), “network” (1.58), and “crosslink” (1.59), are given in: IUPAC INTERNATIONAL, Union Of Pure And Applied Chemistry Macromolecular Division Commission On Macromolecular Nomenclature, Glossary of Basic Terms in Polymer Science, A. D. Jenkins, P. Kratochvil, R. F. T. Stepto, and U. W. Suter, Pure Appl. Chem., 68, 2287 (1996), which is included herein by reference in its entirety. The term “B-stage” is defined as “an intermediate stage in a thermosetting resin reaction in which the plastic softens but does not fuse when heated, and swells but does not dissolve in contact with certain liquids,” see McGraw-Hill Dictionary of Scientific & Technical Terms, 6E, Copyright 2003 by The McGraw-Hill Companies, Inc. The term “network” is defined as a covalently crosslinked 3-dimension polymer network in contrast to a “non-network polymer” or linear polymer which does not having a covalently crosslinked 3-dimension network.

The subject membrane is not particularly limited to a specific construction or application. For example, the subject membrane may be fabricated into flat sheet (film), tubular or hollow fiber configuration and finds utility in a variety of applications including gas separations, pervaporation, forward osmosis (FO), reverse osmosis (RO), nano-filtration (NF), ultra-filtration (UF), micro-filtration (MF) and pressure retarded fluid separations. Representative examples of thin film composite structures are provided in: WO 2005/113121 and US2014/0251897. The present membranes are useful in separations based upon the relative rates of mass transfer of different species across a membrane. A driving force, typically a pressure or a concentration difference, is applied across the membrane so that selected species preferentially pass across the membrane. The membranes may be used for purification, separation or adsorption of a particular species (e.g. salts, organics, ionic species) in the liquid (e.g. aqueous, organic) or gas phase. In particular, the subject membranes exhibit excellent pH and solvent stability and as a consequence, are suitable for use in a wide range of applications including: gas separation, ion exchange, water softening, water purification, ultra-high purity water production in applications such as electronics, metal separation including rare earths, catalysis, remediation of mining waste water, uranium processing, leach mining, and processing of liquids in dairy, sugar, fruit juice and pharmaceuticals and ethanol production in a continuous fermentation/membrane pervaporation system.

The subject membranes may be made by applying a solution of the Troger's base polymer and crosslinking agent to a porous support. The means of application are not particularly limited and include casting, dip coating and spray coating. The polymer and crosslinking agent may be applied from a common solution, or sequentially applied from separate solutions. The solutions may include optional co-reactants including curing catalysts, cure accelerators or promoters, mixtures thereof and the like. Alternatively, such optional co-reactants may be applied from a separate solution. Once applied to the porous support, the polymer and crosslinking agent are cured to form a covalently crosslinked thin film polymer layer upon the porous support. Curing may be accomplished by way of conventional techniques including: exposure to radiation (e.g. infrared, ultraviolet) or chemical initiators (e.g. peroxides, azo compounds, etc.) or heating or a combination thereof. In one embodiment, the polymer and crosslinking agent are combined in a common solution and partially reacted to form a B-stage polymer prior to being applied to a porous support and subsequently cured. In preferred embodiments, the polymer and crosslinking agent are water soluble and are applied to the porous support from one or more aqueous solutions.

The subject membrane may include a bottom layer (back side) of a nonwoven backing web (e.g. PET or polypropylene scrim), a middle layer of a porous support having a typical thickness of about 25-125 μm and top layer (front side) comprising a thin film polymer layer having a thickness typically less than about 1 micron, e.g. from 0.01 micron to 1 micron. The porous support is typically a polymeric material having pore sizes which are of sufficient size to permit essentially unrestricted passage of permeate but not large enough so as to interfere with the bridging over of a thin film polymer layer formed thereon. For example, the pore size of the support preferably ranges from about 0.001 to 0.5 μm. Non-limiting examples of porous supports include those made of: polyetheretherketone, polysulfone, polyether sulfone, polyimide, polyamide, polyetherimide, polyacrylonitrile, crosslinked polyacrylonitrile, poly(methyl methacrylate), polyethylene, polypropylene, and various halogenated polymers such as polyvinylidene fluoride. For most applications, the porous support provides strength but offers little resistance to fluid flow due to its relatively high porosity.

The thin film layer of the subject membrane is a reaction product of Troger's base polymer and a crosslinking agent. More specifically, the Troger's base polymer includes a sub-unit (and more preferably a repeating unit) including a Troger's base moiety represented by Formula I:

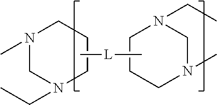

wherein L comprises an arylene group which preferably comprises a fused ring structure including 1 to 4 rings including at least one aromatic (“arylene”) ring. For example, L may be a single ring fused to the Troger's base moiety (e.g. phenylene,) or a multi-ring moiety (e.g. 2 to 4 rings) which may be fused within the Troger's base moiety (e.g. biphenylene, napthalene and spirobisindane). The arylene group is substituted with at least one carboxylic acid (or corresponding salt or ester), or hydroxyl group. Representative examples of preferred polymers (and copolymers) include those having repeating units as represented in the following formulae along with their regioisomers:

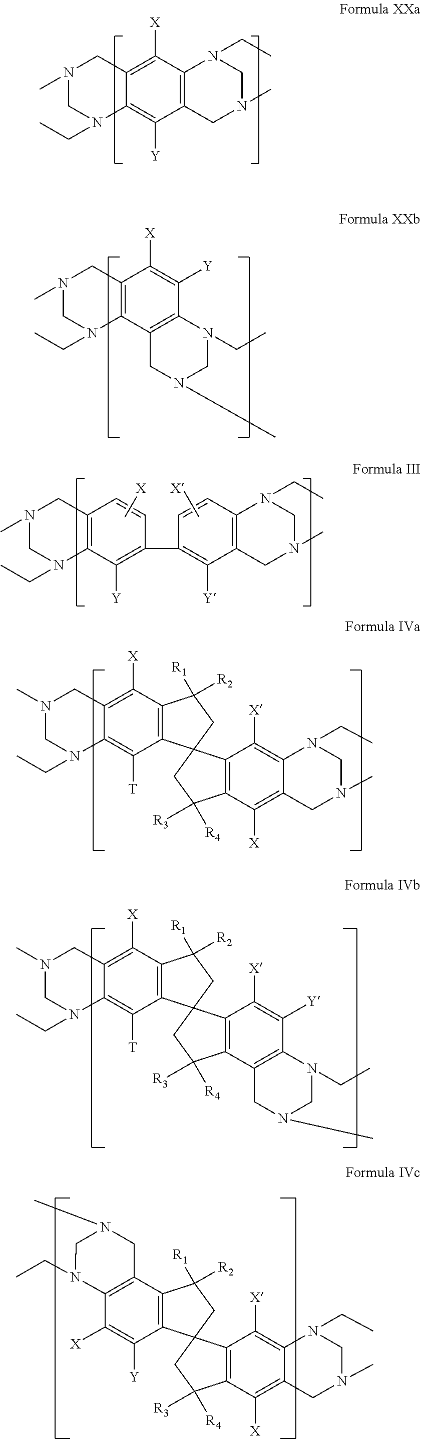

wherein X, Y, X′, and Y′ are independently selected from: carboxylic acid or a corresponding salt or ester, hydroxyl and hydrogen with the proviso that at least one of X, Y, X′, and Y′ is carboxylic acid or a corresponding salt or ester, or hydroxyl; and R₁, R₂, R₃, and R₄ are independently selected from: (hydrogen, alkyl groups comprising from 1 to 6 carbon atoms, and R₁ and R₂ may collectively form a ketone group or a 9,9′-fluorene group, and R₃ and R₄ may collectively form a ketone group or a 9,9′-fluorene group. Representative species of repeating units are shown below:

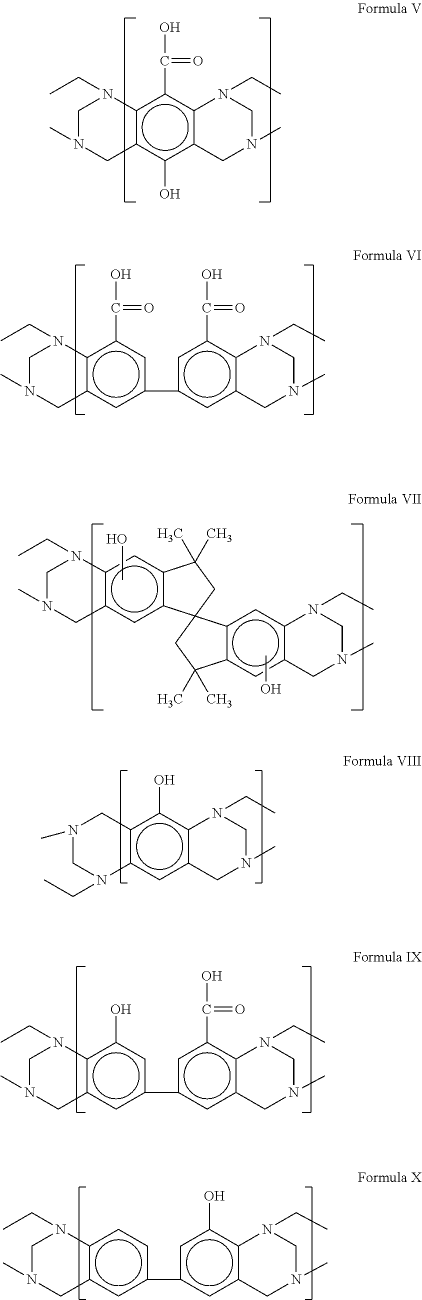

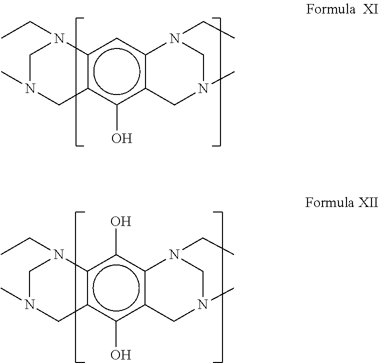

The subject polymer may be prepared using known starting materials and techniques. Several representative reaction pathways are provided below, where the abbreviation TFA is for trifluoroacetic acid.

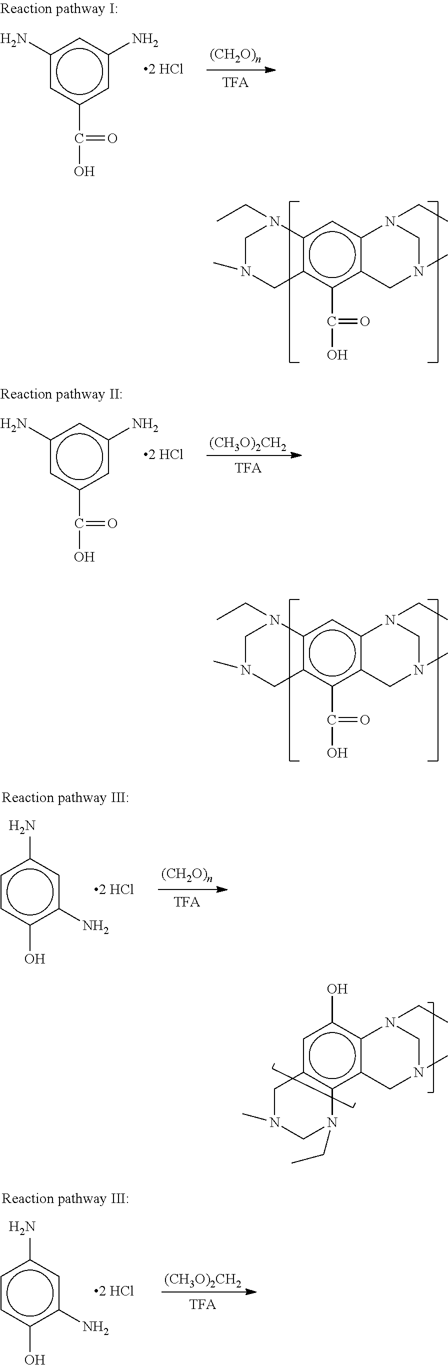

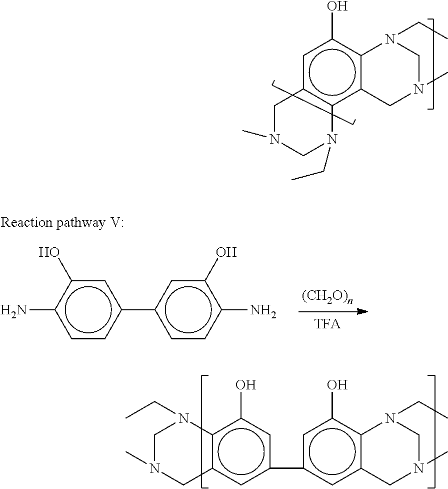

The subject polymers may include additional repeating units or branching or both, i.e. be formed via a copolymerization; however, the subject polymers preferably comprise at least 50 molar %, 75 molar % and more preferably at least 90 molar % of repeating units represented by Formula I (e.g. 50-100 molar %, 75-100 molar % and 90 to 100 molar % of the subject repeat units).

A number of variations of the polymer synthesis are useful for modifying the physical and mechanical properties of the polymer. These variations include structural changes in the co-monomers employed and changes in the stoichiometric ratio of co-monomers employed. Examples of structural changes in the co-monomers employed include addition of one or more substituents to the “L” moiety and variations of co-monomers. Changes in the stoichiometric ratio of co-monomers employed include: variations in equivalent ratio of co-monomers used (can markedly change molecular weight and/or crosslink density and/or hydrophilic functional groups present), inclusion of additional co-monomers. The functionalization of the finished thermoplastic polymers, e.g., to introduce O-carboxymethyl substituents, makes a good extension on the membrane separation application. The high hydrophilicity and surface charge are preferred for higher selectivity in gas separations, or water flux and solute rejection in liquid separations. A representative reaction pathway is provided below where the two separate structural units present in the copolymer are separately shown.

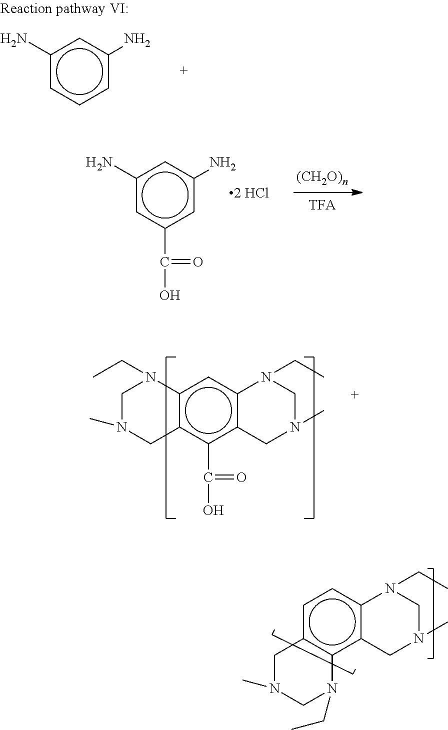

Numerous variations within the Troger's base polymer synthesis are useful for production of novel polymers with modified physical and mechanical properties. A particularly useful variation involves partial replacement of the monomer containing a polar functional group, such as —OH, —OR —COOH, with a non-functionalized monomer. A representative example is given in Reaction pathway VI where a portion of the —OH functional monomer, (2,4-diamino phenol) is replaced with a non-functional monomer; (e.g. 1,3-phenylenediamine) where the two separate structural units present in the copolymer are separately shown. Incorporation of the non-functionalized monomer can beneficially modify solubility and processability of the resultant Troger's base polymer.

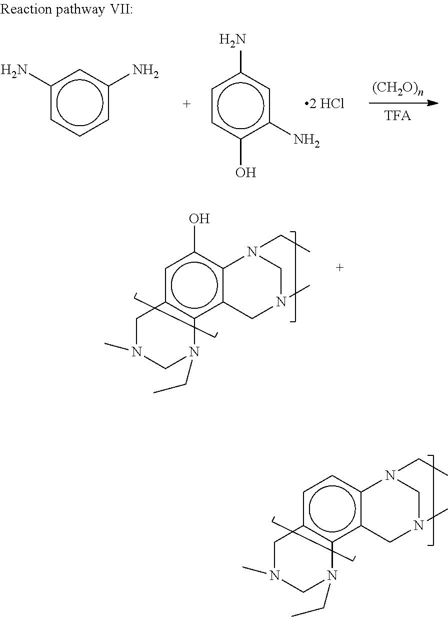

Another particularly useful variation involves partial replacement of the monomer containing functional group, such as, for example, —OH, —COOH; with a monomer containing a different functional group. A representative example is given in Reaction pathway VIII where a

—COOH functional monomer, e.g., 3,5-diaminobenzoic acid, and a —OH functional monomer, e.g., 2,4-diaminophenol, are reacted in the copolymerization and where the two separate structural units present in the copolymer are separately shown. The Troger's base polymer made with only 3,5-diaminobenzoic acid has low organic solvent solubility, whereas the Troger's base polymer made with 2,4-diaminophenol has comparatively much greater organic solvent solubility. Thus, this synthetic scheme can be employed to produce Troger's base polymers with —COOH functionality but with improved solubility in organic solvents. The improved solubility can aid in the preparation of membranes and thin film composites.

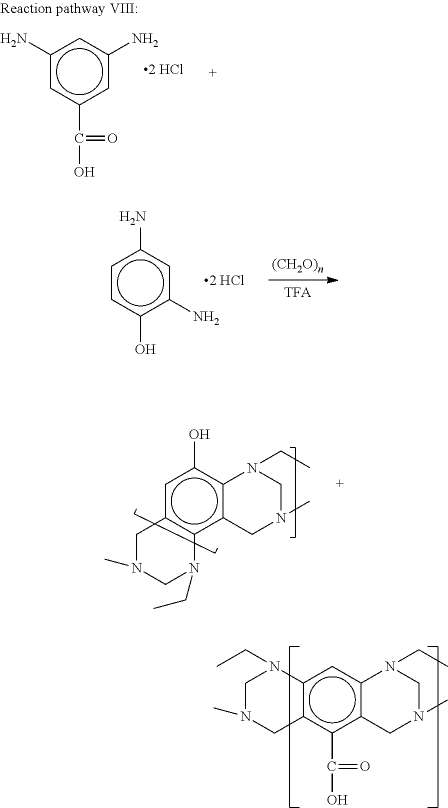

The Troger's base polymer preferably includes a chain terminating group, which may optionally include one or more functional groups amenable to further reaction to provide covalent crosslinking or chain extension through the polymer end groups. The use of selective chain terminating groups can provide Troger's base polymers with improved solubility, stability, reactivity, and/or processability. Incorporation of certain chain terminating groups, for example, phenyl, can remove unwanted end groups that may interfere with incorporation and/or reaction of various thermosettable groups. Incorporation of isopropylphenyl chain terminating groups can provide methine groups giving enhanced reactivity with bis(azide)s and bis(sulfonylazide)s. Incorporation of hydroxyphenyl (or carboxyphenyl) chain terminating groups can provide the hydroxy (or carboxylic acid) group for conversion to the thermosettable cyanate or glycidyl ether (or glycidyl ester group). A preferred chain terminating group is represented by Formula XIII.

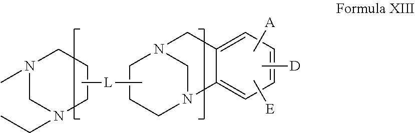

wherein A, D and E are independently selected from: hydrogen, hydroxyl, carboxylic acid, cyanate, epoxide, glycidyl ether, glycidyl ester, or a hydrocarbon group including from 1 to 8 carbon atoms (e.g. alkyl, alkenyl, alkynyl and benzyl) and which may optionally include an ether linkage (e.g. alkyl ether, alkenyl ether and alkynyl ether, benzyl ether) and which may be unsubstituted or substituted with a ketone or epoxy group. Representative A, D, E groups include:

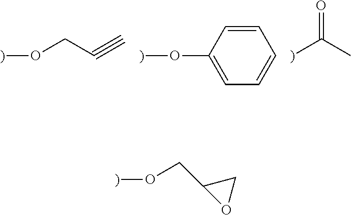

Spirobisindane monomers may be prepared using the methods described by Chen, W-F.; Lin, H-Y.; Dai, S. A.; Organic Letters, 6, 14, 2341-2343 (2004); Faler, G. R.; Lynch, J. C.; U.S. Pat. No. 4,701,566 (Oct. 20, 1987); Ito, M.; Iimuro, S.; U.S. Pat. No. 5,339,783 (Mar. 21, 1995); Curtis, R. F.; Lewis, K. O.; J. Chem. Soc., 418-421 (1962); Baker, W.; J. Chem. Soc., 1678-1681 (1934); Fisher, C. H.; Furlong, R. W.; Grant, M.; Journal of the American Chemical Society 58, 820-822 (1936); Baker, W.; Besly, D. M.; J. Chem. Soc., 1421-1424 (1939); Baker, W.; Besly, D. M.; J. Chem. Soc., 347-353 (1938), Ma, X; Swaidan, Y. B.; Zhu, Y.; Litwiller, E.; Jouiad, I. P.; Han, Y.; Macromolecules, 45, 3841-3849 (2012); Li, S.; Jo, H. J.; Han, S. H.; Park, C. H.; Kim, S.; Budd, P. M.; Lee, Y. M.; Journal of Membrane Science, 434, 137-147 (2013).

Quaternary ammonium groups may be formed within a part or all of the Troger's base polymer repeat units via reaction of a tertiary amine group within the bicyclic diamine structure of the main chain of the Troger's base polymer with an alkyl halide (Menshutkin reaction), dialkyl sulfate, alkylarylsulfonates, or trialkyl phosphate. Iodomethane, dimethyl sulfate, diethyl sulfate, toluenesulfonic acid methyl ester, or trimethyl phosphate are particularly preferred. Functional groups in the Troger's base polymer that are inert to the reactant and solvent used, if any, are preferred. Solvents useful for the quaternization reaction include aprotic solvents, such as dimethylsulfoxide, as well as acetonitrile. An excess of the alkyl halide, dialkyl sulfate or trialkyl phosphate may be used as both reactant and solvent or co-solvent. Methods used for quaternization reactions are given in J. Am. Chem. Soc., 113, 2873-2879 (1991); J. Org. Chem., 72, 9663-68 (2007); J. Chem. Soc., Perkin Trans. 2, 325-329 (1979); Dyes and Pigments 15, 83-88 (1991). Quaternization of the Troger's base polymers can beneficially improve water solubility, providing an aqueous solution from which a membrane can be fabricated and then crosslinked.

Crosslinking agents useful in the present invention include a multifunctional epoxy compounds and multifunctional azide compounds. As used in this context, “multifunctional” refers to preferably from 2 to 4 glycidyl ether or esters groups per molecule, or 2 to 4 azide groups per molecule.

The term azide refers to (—N═N═N) and expressly includes sulfonyl azides. General methods for preparation of compounds containing the azide functionality are given by Stefan Braise, Carmen Gil, Kerstin Knepper, and Viktor Zimmermann in “Organic Azides: An Exploding Diversity of a Unique Class of Compounds” Angew. Chem. Int. Ed. 44, 5188-5240 (2005). Other bis(azide)s [and poly(azide)s]which may be employed to prepare the crosslinkable and crosslinked compositions of the present invention include the bis(acyl azide)s containing the moiety:

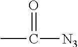

The acyl azide functionality may be prepared via reaction of a carboxylic acid group in the presence of trichloroacetonitrile, triphenylphosphine, and sodium azide using conditions given by J.-G. Kim, D. O. Jang, Synlett, 2072-2074 (2008). In another synthetic method, the aldehyde group is reacted in the presence of iodobenzene dichloride and sodium azide using acetonitrile solvent under an inert atmosphere, as per conditions reported by X.-Q. Li, X.-F. Zhao, C. Zhang, Synthesis, 2589-2593 (2008). Reaction of the aldehyde group with iodine azide produces the acyl azide group which may be converted to the carbamoyl azide group via Curtius rearrangement at reflux in acetonitrile solvent using the method of L. G. Marinescu, J. Thinggaard, I. B. Thomsen, M. Bols, Journal of Organic Chemistry, 68, 9453-9455 (2003):

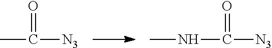

An extension of this synthetic method utilizes polymer supported iodine azide as reported by L. G. Marinescu, C. M. Pedersen, M. Bols, Tetrahedron, 61, 123-127 (2005). The benzyl azide functionality may be prepared via reaction of a secondary-benzyl alcohol group:

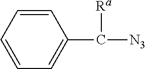

where R^{a} is phenyl or primary alkyl, preferably methyl. Methods such as the bismuth (III) catalyzed direct azidation of the secondary-benzyl alcohol group may be employed, as reported by J. Tummatorn, et al., Synthesis, 47, 323-329 (2015). Reaction of azidotrimethylsilane with the secondary-benzyl alcohol group in the presence of copper (II) triflate provides the benzyl azide functionality using the method of P. Khedar, et al., 25, 515-518 (2014). Allylic azide functionality may be prepared via azidation reaction of a primary, secondary or tertiary allylic alcohol:

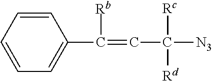

where R^{b} is H, methyl or phenyl; R^{c} is H, alkyl or phenyl; R^{d} is H or methyl. Reaction of azidotrimethylsilane with the allyl-containing group in the presence of silver trifluoromethane sulfonate and toluene solvent provides the allylic azide functionality using the method of M. Rueping, C. Vila, U. Uria, Org. Lett., 14, 768-771 (2012).

A representative aliphatic multifunctional azide is represented by:

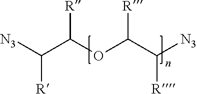

where each R′, R″, R′″ and R″″ are independently selected from hydrogen and alkyl (e.g. having from 1 to 6 carbon atoms but preferably methyl) and n is an integer from 1 to 50 and more preferably 2 to 10.

A representative aromatic multifunctional azide is represented by:

N₃—Z′—N₃

where Z′ is an arylene group comprising from 1 to 3 aromatic rings, which may be unsubstituted or optionally substituted, e.g. sulfonate, sulfonic acid, etc. The arylene group may include fused aromatic rings or rings connected via linking groups such as an ether, ketone, or alkylene group. A representative example is: 4,4′-diazido-2,2′-stilbenedisulfonic acid disodium salt tetrahydrate.

A preferred class of sulfonyl azides is represented by:

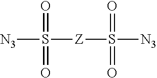

wherein Z is an arylene group comprising from 1 to 3 aromatic rings, which may be unsubstituted or optionally substituted, e.g. with sulfonate, sulfonic acid, groups. The arylene group may include fused aromatic rings or rings connected via linking groups such as an ether, ketone, or alkylene group. A preferred subclass of multifunctional azides is represented by:

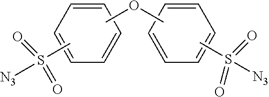

Another preferred class of sulfonyl azides is represented by, where the sulfonate moieties are beneficially used to impart aqueous solubility:

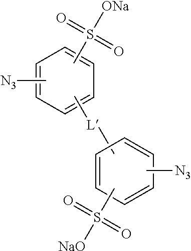

and wherein L′ is selected from: —CH₂—, —CH₂—CH₂—, —CH═CH—, —CH═C(—CH₃)—, —O—, —O—CH₂—CH₂—, —O—CH₂—CH₂—O—, —S—(═O)₂, —CH₂—O—CH₂—, —CH₂—CH(—CH₃)—, —C(—CH₃)₂—, —CH(—CH₃)—, a direct bond, >C═O, and —C(═O)—CH═CH—.

Representative multifunctional azide compounds include: 4,4′-diazido-2,2′-stilbenedi-sulfonic acid disodium salt tetrahydrate (including cis- and trans-isomers or a mixture of both cis- and trans-isomers); 4,4′-diazido-2,2′-stilbenedisulfonic acid; 4,4′-diazido-2,2′-stilbenedisulfonic acid disodium salt; 4,4-diazido-2,2′-alpha-methylstilbenedisulfonic acid disodium salt tetrahydrate; 4,4-diazidodiphenylmethane; 2,2-bis(4-azidophenyl)propane; 1,3,5-tris(azidomethyl)benzene; 1,3,5-tris(azidomethyl)-2,4-benzene disulfonic acid; 1,3,5-tris(azidomethyl)-2,4-benzene disulfonic acid disodium salt; 4,4′-diazidostilbene; 4,4′-diazido-alpha-methylstilbene; 4-phenylenebis(azide); 4,4′-diazidobenzophenone; 4,4′-diazidodiphenyl; 4,4-diazidodiphenyl ether; 4,4′-diazidodiphenyl sulfone; 1,2-benzoquinonediazide-4-sulfonic acid sodium salt; 4,4′-diazidodibenzyl; 4,4′-diazidochalcone, bis(N-diazo)-tris(O-acetyl)-2-deoxystreptamine, 2,6-bis(4-azidobenzylidene)-4-methylcyclohexanone and polyethylene glycol bis(azide).

A preferred class of multifunctional epoxy compounds includes polyglycidyl ether compounds as represented by:

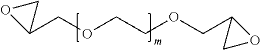

where m is an integer from 1 to 50, preferably from 3 to 12.
Another preferred class of multifunctional epoxy compounds includes compounds represented by:

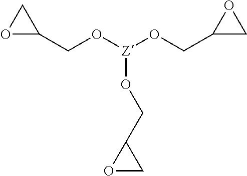

wherein Z′ is an arylene group comprising from 1 to 3 aromatic rings which may be unsubstituted or substituted, e.g. with alkyl (e.g. 1-6 carbon atoms), alkyoxy, alkenyl, or nitrile groups. A preferred species is represented by:

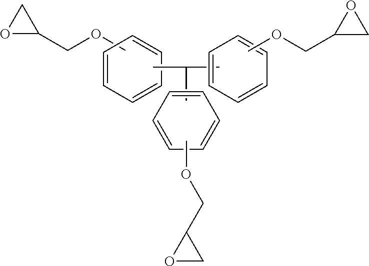

Another preferred class of multifunctional epoxy compounds is represented by:

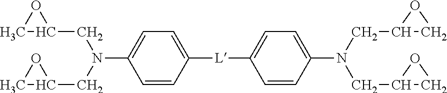

wherein L′ is the same as defined above.

Representative multifunctional epoxy compounds include: tris(glycidyloxyphenyl)methane, 1,1,1-tris(4-glycidyloxyphenyl)ethane; phenol formaldehyde novolac epoxy resins having an average functionality ≥2; cresol formaldehyde novolac epoxy resins having an average functionality ≥2; tris (2,3-epoxypropyl)isocyanurate; 4,4′-methylenebis(N,N-diglycidylaniline); tetraphenylolethane glycidyl ether and N,N-diglycidyl-4-glycidyloxyaniline.

As described above, subject Troger's base polymer is reacted with the aforementioned crosslinking agent and cured to form a thin film layer upon a porous support. Several representative reaction pathways are provided below.

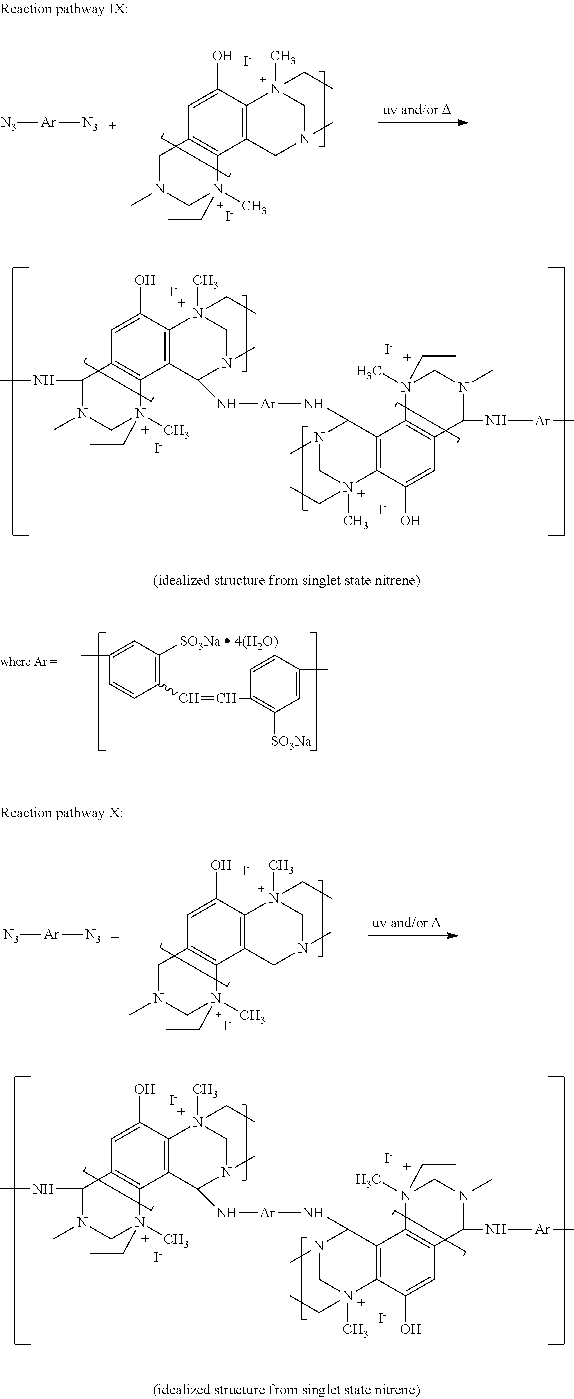

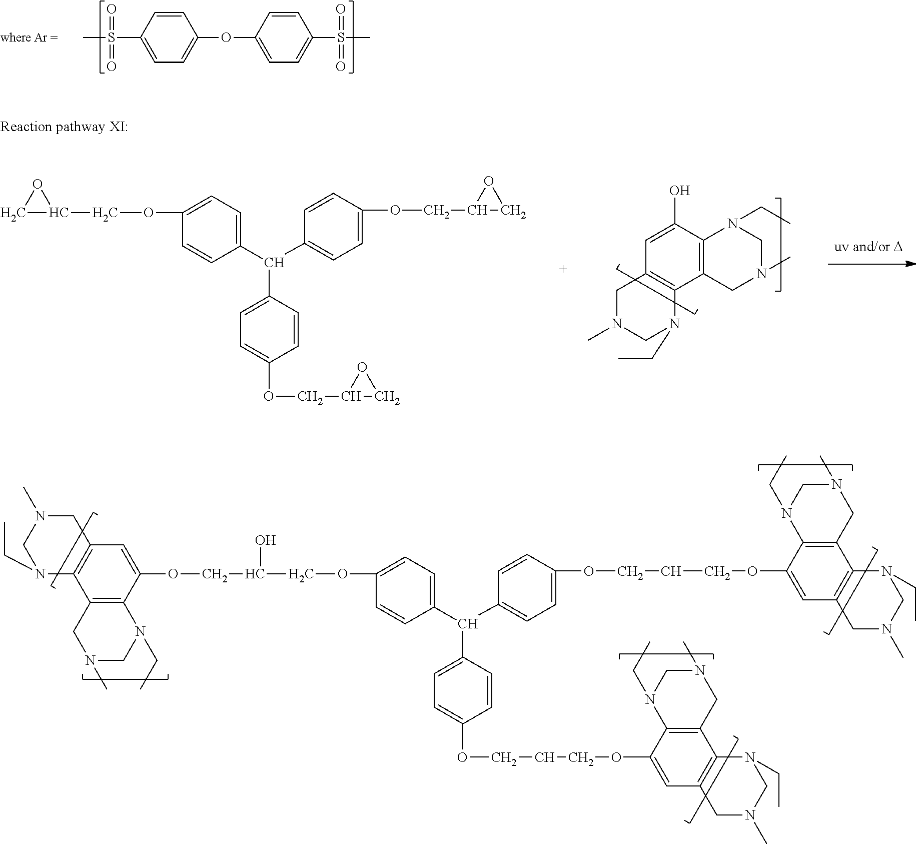

B-staging or prepolymerization of copolymerizable mixtures wherein at least one comonomer contains a thermosettable moiety can be accomplished by using lower temperatures and/or shorter curing times and/or reduced catalyst concentration. Curing of the thus formed B-staged (prepolymerized) copolymers can then be accomplished at a later time or immediately following B-staging (prepolymerization) by increasing the temperature and/or curing time.

It is to be understood that the formulae and reaction pathways provided herein are not intended to represent every possible regioisomer and combination of regioisomers present. Likewise, the formulae and reaction pathways do not show the chiral centers and combination of diasteroisomers which may be present. Nevertheless, those skilled in the art will appreciate that such species form part of the present invention. Tetrahedron Letters, 45, pages 5601-5604 (2004) is representative of the literature providing discussion and illustration of various isomeric forms present in Troger's bases.

### EXAMPLES

### Example 1: Quaternization of Hydroxy Functional Troger's Base Polymer in Dimethylsulfoxide Solvent

A hydroxy functional Troger's base polymer was prepared by reacting 2,4-diaminophenol dihydrochloride and paraformaldehyde in trifluoroacetic acid. Thermogravimetric analysis (TGA) of the hydroxy functional Troger's base polymer (3.822 milliligrams) gave an onset to Td and volatiles (% weight) lost up to onset to Td after prehold at 150° C. for 60 minutes of 209.16° C. and 8.07%, respectively. Hydroxy functional Troger's base polymer (2.00 grams, 12.488 millimoles based on a 160.154 gram/mole repeat unit, uncorrected for entrained volatiles) and dimethylsulfoxide (40 milliliters) were measured into a glass bottle under dry nitrogen. A magnetic stirring bar was added followed by addition of methyl iodide (35.45 grams, 249.753 millimoles, 20 molar excess). Magnetic stirring of the contents of the sealed bottle commenced giving a dark amber colored solution. After 74 hours 10 minutes, the slurry was vacuum filtered over a medium fritted glass funnel to remove co-produced trimethylsulfoxonium iodide. The filtrate solution was diluted with DI water (80 milliliters) while swirling to mix. The resultant precipitate was recovered by vacuum filtration on a medium fritted glass funnel, washed twice with DI water to cover, and dried in the vacuum oven at 100° C. for 25 hours 8 minutes, to give a medium brown colored powder (2.03 grams). TGA of a sample (3.015 milligrams) gave an onset to Td and volatiles (% weight) lost up to onset to Td after prehold at 150° C. for 60 minutes of 190.80° C. and 15.77%, respectively. Titration demonstrated 24.2-25.1% quaternization for the reaction of various hydroxy functional Troger's base polymers performed in dimethylsulfoxide. Thermal desorption/pyrolysis GC MS and MALDI MS analyses of the present hydroxy functional Troger's base co-polymer which had been quaternized versus the non-quaternized hydroxy functional Troger's base copolymer reactant confirmed conversion to the quaternized product. Specifically, for the quaternized hydroxy functional Troger's base copolymer, the 650° C. pyrolysis gas chromatograms demonstrated substantially enhanced fragment peaks at 11.25 minutes with m/z=133, 12.11 and 12.70 minutes both with m/z=147, all resulting from quaternization, concurrent with disappearance of fragment peaks at 14.73 minutes with m/z=148, and 15.25, 15.89, and 16.36 minutes, all characteristic of the non-quaternized hydroxy functional Troger's base copolymer reactant.

### Example 2: Quaternization of Hydroxy Functional Troger's Base Polymer in Acetonitrile

The quaternization of Example 1 was repeated except that acetonitrile (90 milliliters) replaced the dimethylsulfoxide used as solvent and a different work-up method resulted. Magnetic stirring of the contents of the sealed bottle commenced giving a brown colored slurry maintained during the entire reaction. After 74 hours 46 minutes, the slurry was vacuum filtered over a medium fritted glass funnel providing a brown colored powder which was washed on the filter with acetonitrile to cover. The resultant damp powder was dried in the vacuum oven at 100° C. for 25 hours 8 minutes, giving a medium brown colored powder. TGA (3.702 milligrams) gave an onset to Td and volatiles (% weight) lost up to onset to Td after prehold at 150° C. for 60 minutes of 188.38° C. and 14.85%, respectively. Titration demonstrated 11.8-12.6% quaternization for the reaction of various hydroxy functional Troger's base polymers performed in acetonitrile.

### Example 3: Quaternization of Partially Branched Hydroxy Functional Troger's Base Copolymer in Dimethylsulfoxide Solvent

2,4-Diaminophenol dihydrochloride (9.03 grams, 45.824 millimoles, 91.647 primary amine milliequivalents), tetrakis(4-aminophenyl)methane (2.180 grams, 5.730 millimoles, 22.918 primary amine milliequivalents), and paraformaldehyde (6.88 grams, 229.135 millimoles) were reacted in trifluoroacetic acid to form a partially branched hydroxy functional Troger's base copolymer. TGA (4.582 milligrams) gave an onset to Td and volatiles (% weight) lost up to onset to Td after prehold at 150° C. for 60 minutes of 207.74° C. and 5.26%, respectively. MALDI MS analysis demonstrated the 160 dalton repeat unit expected for the C₉H₉ON₂ repeat structure but now along with a higher mass series with the repeat unit for the branched Troger's base structure resulting from reaction of the tetrakis(4-aminophenyl)methane. Representative of the lower mass series detected were 501, 661.3, 821.4, 981.4, 1141 dalton. Representative of the higher mass series detected were 1147.5, 1307.6, 1467.6, 1627.7, 1788.8 dalton. A portion of the partially branched hydroxy functional Troger's base copolymer (2.00 grams, 13.874 millimoles based on a 144.154 gram/mole repeat unit, uncorrected for entrained volatiles), and dimethylsulfoxide (40 milliliters) were measured into a glass bottle under dry nitrogen. A magnetic stirring bar was added followed by addition of methyl iodide (40.92 grams, 288.291 millimoles, 20 molar excess). Magnetic stirring of the contents of the sealed bottle commenced giving a dark amber colored solution. After 92 hours 37 minutes, the slurry was vacuum filtered over a medium fritted glass funnel to remove co-produced trimethylsulfoxonium iodide. The filtrate solution was diluted with DI water (200 milliliters) while swirling to mix. The resultant powder was recovered by gravity filtration over paper and washed twice with DI water to cover. After drying in the vacuum oven at 100° C. for 25 hours 52 minutes and then at 125° C. for 118 hours 43 minutes, a medium orange brown colored powder (2.84 grams) was obtained. TGA (4.929 milligrams) gave an onset to Td and volatiles (% weight) lost up to onset to Td after prehold at 150° C. for 60 minutes of 190.58° C. and 14.71%, respectively.

### Example 4: Quaternization of Partially Branched Hydroxy Functional Troger's Base Copolymer in Acetonitrile Solvent

The quaternization of Example 3 was repeated except that acetonitrile (90 milliliters) replaced the dimethylsulfoxide used as solvent and a different work-up method resulted. Magnetic stirring of the contents of the sealed bottle commenced giving a dark amber colored slurry. After 123 hours 42 minutes, the slurry was gravity filtered over paper to provide a powder which was washed on the filter with acetonitrile to cover. After air drying for 17 hours 41 minutes, then drying in the vacuum oven at 100° C. for 27 hours 9 minutes, a medium brown orange colored powder (2.10 grams) was obtained. TGA (5.283 milligrams) gave an onset to Td and volatiles (% weight) lost up to onset to Td after prehold at 150° C. for 60 minutes of 193.90° C. and 12.33%, respectively.

### Example 5: Quaternization of Isomeric Partially Branched Hydroxy Functional Troger's Base Copolymer

2,5-Diaminophenol dihydrochloride (1.20 grams, 6.090 millimoles, 12.179 primary amine milliequivalents), tetrakis(4-aminophenyl)methane (0.2896 grams, 0.761 millimole, 3.045 primary amine milliequivalents), and paraformaldehyde (0.91 gram, 30.307 millimoles) were reacted in trifluoroacetic acid to form a partially branched hydroxy functional Troger's base copolymer. TGA (3.909 milligrams) gave an onset to Td and volatiles (% weight) lost up to onset to Td after prehold at 150° C. for 60 minutes of 204.32° C. and 11.29%. Isomeric partially branched hydroxy functional Troger's base copolymer (1.00 gram, 6.9370 millimoles based on a 144.154 gram/mole repeat unit, uncorrected for entrained volatiles) and acetonitrile (45 milliliters) were measured into a glass bottle under dry nitrogen. A magnetic stirring bar was added followed by addition of methyl iodide (20.5 grams, 144.4272 millimoles, 20.8 molar excess). Magnetic stirring of the contents of the sealed bottle commenced and after 334 hours 26 minutes the slurry was gravity filtered over paper giving a red brown colored product which was washed with acetonitrile to cover. After air drying for 1 hour 35 minutes, the powder (1.27 grams) was dried in the vacuum oven at 100° C. for 17 hours 5 minutes giving a medium brown orange colored powder (1.02 grams). TGA (5.513 milligrams) gave an onset to Td and volatiles (% weight) lost up to onset to Td after prehold at 150° C. for 60 minutes of 192.54° C. and 12.35%, respectively.

### Example 6: Quaternization of Hydroxy Functional Troger's Base Polymer Using Dimethyl Sulfate

Hydroxy functional Troger's base polymer (2.00 grams, 12.488 millimoles based on a 160.154 gram/mole repeat unit, uncorrected for entrained volatiles) and acetonitrile (90 milliliters) were measured into a glass bottle under dry nitrogen. TGA (7.034 milligrams) of the hydroxy functional Troger's base polymer used gave an onset to Td and volatiles (% weight) lost up to onset to Td after prehold at 150° C. for 60 minutes of 218.37° C. and 2.48%, respectively. Dimethyl sulfate (16.30 grams, 129.23 millimoles, 10.35 molar excess) was added. Mechanical shaking of the sealed bottle commenced giving a brown colored slurry which was maintained during the entire reaction. After a cumulative 241 hours 4 minutes, the slurry was vacuum filtered over a medium fritted glass funnel providing a powder which was washed on the filter with acetonitrile to cover. The resultant damp powder was dried in the vacuum oven for 23 hours 46 minutes giving a medium brown colored powder (2.15 grams). TGA (6.711 milligrams) gave an onset to Td and volatiles (% weight) lost up to onset to Td after prehold at 150° C. for 60 minutes of 239.52° C. and 6.42%, respectively.

### Example 7: Quaternization of Isopropylphenyl Terminated Hydroxy Functional Troger's Base Polymer

4-Isopropylaniline (1.24 grams, 9.171 millimoles), 2,4-diaminophenol dihydrochloride, (6.00 grams, 30.448 millimoles) and paraformaldehyde (4.21 grams 0.1402 mole) were reacted at 70° C. in trifluoroacetic acid (60 milliliters) forming an isopropylphenyl terminated hydroxy functional Troger's base copolymer. TGA (5.3920 milligrams) gave an onset to Td, end of Td, and volatiles (% weight) lost up to onset to Td after prehold at 150° C. for 60 minutes of 215.98° C., 251.43° C., and 4.26%, respectively. Isopropylphenyl terminated hydroxy functional Troger's base copolymer (2.00 grams, nominal 12.488 hydroxy milliequivalent based on a 160.154 gram/mole repeat unit), methyl iodide (35.80 grams, 0.2522 mole) and acetonitrile (90 milliliters) were weighed under dry nitrogen into a glass bottle along with a magnetic stirring bar. The bottle was sealed and stirring commenced for 141 hours 52 minutes, then the slurry was vacuum filtered over a medium fritted glass funnel providing a powder which was washed on the filter with acetonitrile to cover. The resultant damp powder (3.08 grams) was placed into the vacuum oven at 100° C. for 52 hours 30 minutes to give a brown colored powder (1.57 grams). TGA (5.0640 milligrams) gave an onset to Td and volatiles (% weight) lost up to onset to Td after prehold at 150° C. for 60 minutes of 190.49 5° C. and 9.67%, respectively. Titration demonstrated 12.0-12.4% quaternization.

### Example 8: Troger's Base Copolymer Membrane Crosslinked with an Epoxy Resin

A stock solution of hydroxy functional partially branched Troger's base copolymer described in Example 3 was prepared by adding the copolymer to a 50/50 solvent blend of chloroform and methanol. The solution was heated in an oil bath at 70° C. for 7-8 hrs. under reflux, then filtered through a 0.45 micron PTFE syringe filter. Tris(4-hydroxyphenyl)methane triglycidyl ether was dissolved in chloroform to obtain a 1 wt. % solution. Benzyltriethylammonium chloride catalyst was dissolved in methanol to obtain a solution with 0.5 wt. % solids. Solutions of hydroxy functionalized partially branched Troger's base copolymer, tris(4-hydroxyphenyl)methane triglycidyl ether and benzyltriethylammonium chloride were combined to get various ratios of the epoxy crosslinker and 1 wt. % of benzyltriethylammonium chloride with respect to the copolymer. Solutions were heated in an oil bath at 70° C. for 4 hrs under reflux. The resulting solutions were coated on SolSep™ PAN support using a Gardco wire rod #2 to prepare thin film composite (TFC) membranes. The membranes were allowed to dry in the fume hood, then cured at 70° C. overnight in a vacuum oven. The flux and rejection (CuSO₄) of the membranes were then determined and are summarized below. As shown, membranes made using a higher percentage of crosslinker showed improved rejection.

| Epoxy | Flux | CuSO₄ Rejection |
|---|---|---|
| wt % | [Liters/m² · hour · bar] | [%] |
| 6 | 2.9 | 44 |
| 13 | 2.2 | 40 |
| 26 | 0.3 | 87 |
| 0 | 42 | 6 |

The membranes were further tested for polyethylene glycol (PEG) rejection as a function of molecular weight for membranes with various loadings of the crosslinker. Results are provided below:

| PEG Mw | 150 | 194 | 238 | 282 | 326 | 370 | 414 | 458 | 502 | 546 | 590 | 634 | 678 | 722 | 766 |
|---|---|---|---|---|---|---|---|---|---|---|---|---|---|---|---|
| 0% Epoxy | 0 | 0 | 2 | 1 | 1 | 0 | 4 | 4 | 4 | 3 | 4 | 2 | 2 | 2 | 3 |
| 6% Epoxy | 20 | 27 | 31 | 32 | 37 | 37 | 38 | 39 | 40 | 41 | 43 | 42 | 43 | 44 | 44 |
| 13% Epoxy | 18 | 26 | 31 | 35 | 37 | 38 | 40 | 41 | 42 | 42 | 44 | 45 | 45 | 47 | 42 |
| 26% Epoxy | 64 | 73 | 78 | 81 | 85 | 84 | 85 | 84 | 83 | 83 | 83 | 83 | 78 | 78 | 79 |

### Example 9: Troger's Base Copolymer Membrane Crosslinked with Bis(Sulfonyl Azide) (BSA) Using UV Radiation Curing

A stock solution of hydroxy functional partially branched Troger's base copolymer described in Example 3 was prepared as described in Example 8. A melt blend of bis(sulfonyl azide) 4,4′-oxybis(benzenesulfonyl azide) (20-25%) with Irganox 1010 stabilizer (Dynamite Nobel GmbH) was dissolved in chloroform to obtain a 1 wt. % solution. Solutions of the Troger's base copolymer and the BSA were combined in different ratios to vary the amount of crosslinker from 0.5 wt. % to 30 wt. %. Resulting solutions were coated on SolSep™ PAN support using a Gardco wire rod #2, and dried at 80° C. for 30 minutes in an oven. Membranes were cured by exposing to UV light using with a dose of 2466 milliJoules/cm², 767 milliJoules/cm², 414 milliJoules/cm² and 2815 milliJoules/cm² in the UVA (315-400 nm), UVB (280-315 nm), UVC (100-280 nm) and UVV (178 nm) regions, respectively.

### Example 10: Crosslinking of Quaternized Hydroxy Functional Troger's Base Polymer Using an Aryl bis(azide)

Quaternized hydroxy functional Troger's base polymer (Q-TB-OH) (0.2 gram) described in Example 1 was added to 20 grams of deionized water in a round bottom flask. The slurry was heated in an oil bath at 100° C. for 4 hours under reflux to obtain a solution. The solution was filtered through a 5 micron Nylon syringe filter to remove particulates. The filtered solution was coated on as received SolSep™ PAN using a Gardco wire rod #2. Resulting coating was dried at 80° C. for 15 minutes in a vacuum oven. 4,4′-Diazido-2,2′-stilbenedisulfonic acid disodium salt tetrahydrate (SSA) (Sigma Aldrich) was added to water to obtain a 2 weight % solution. SAA solution was applied on top of the Q-TB-OH coating using a pipette to cover the whole coating surface. Excess SSA crosslinker solution was removed and the coating was dried in the vacuum oven at 80° C. for 15 minutes and cured by exposing to UV light with a dose of 2466 milliJoules/cm², 767 milliJoules/cm², 414 milliJoules/cm² and 2815 milliJoules/cm² in the UVA (315-400 nm), UVB (280-315 nm), UVC (100-280 nm) and UVV (178 nm) regions respectively. Flux of water and CuSO₄ rejection for the crosslinked and uncrosslinked membrane after a seven day soak in water are shown in the table below. It can be seen that the crosslinked membrane has a much higher rejection compared to the uncrosslinked membrane.

| | Flux | CuSO₄ rejection |
|---|---|---|
| | [Liters/m² · hour · bar] | [%] |
| Uncrosslinked | 26 | 14 |
| Crosslinked | 3.8 | 92 |

PEG rejection as a function of molecular weight for the crosslinked and uncrosslinked membrane is is shown in the table below:

| PEG Mw [Da] | 150 | 194 | 238 | 282 | 326 | 370 | 414 | 458 | 502 | 546 | 590 | 634 |
|---|---|---|---|---|---|---|---|---|---|---|---|---|
| Uncrosslinked | 6 | 7 | 10 | 11 | 12 | 13 | 13 | 14 | 14 | 14 | 15 | 14 |
| rejection [%] | | | | | | | | | | | | |
| Crosslinked | 52 | 64 | 74 | 81 | 86 | 87 | 88 | 89 | 90 | 90 | 91 | 90 |
| rejection [%] | | | | | | | | | | | | |

### Example 11: Crosslinking of Quaternized Isopropylphenyl Terminated Hydroxy Functional Troger's Base Polymer Using an Aryl Bis(Azide)

Quaternized isopropylphenyl terminated hydroxy functional Troger's base polymer described in Example 7 was crosslinked with SSA using the method described in Example 10. Flux of water through this membrane was measured as 1.3 Liters/m²·hour·bar and CuSO₄ rejection as 70.2%. PEG rejection as a function of PEG molecular weight for this membrane is shown in the table below:

| PEG Mw [Da] | 150 | 194 | 238 | 282 | 326 | 370 | 414 | 458 | 502 | 546 | 590 | 634 |
|---|---|---|---|---|---|---|---|---|---|---|---|---|
| Rejection [%] | 43 | 47 | 56 | 60 | 64 | 65 | 66 | 67 | 68 | 68 | 68 | 67 |

### Example 12: Crosslinking of Quaternized Partially Branched Hydroxy Functional Troger's Base Copolymer

Quaternized partially branched hydroxy functional Troger's base copolymer described in Example 3 was crosslinked with SSA using the method described in Example 10. Flux of this membrane was measured as 1.9 Liters/m²·hour·bar and CuSO₄ rejection as 87%. PEG rejection as a function of PEG molecular weight for this membrane is shown in the table below:

| PEG Mw [Da] | 150 | 194 | 238 | 282 | 326 | 370 | 414 | 458 | 502 | 546 | 590 | 634 |
|---|---|---|---|---|---|---|---|---|---|---|---|---|
| Rejection [%] | 62 | 70 | 77 | 81 | 83 | 85 | 86 | 86 | 86 | 87 | 88 | 87 |

### Example 13: Crosslinking of Hydroxy Functional Troger's Base Polymer Quaternized Using Dimethyl Sulfate

Hydroxy functional Troger's base polymer quaternized with dimethyl sulfate described in Example 6 was crosslinked with SSA using the method described in Example 10.

### Example 14: Crosslinking of Quaternized Hydroxy Functional Troger's Base Polymer Using an Aliphatic bis(azide)

1,11-Diazido-3,6,9-trioxaundecane (Sigma Aldrich) was dissolved in DI water to obtain a 2 weight % solution. A solution of quaternized hydroxy functional Troger's base polymer was prepared as previously described. The two solutions were mixed in various ratios to obtain different loadings of 1,11-diazido-3,6,9-trioxaundecane relative to the polymer in the blend solution. The blend solutions were coated on SolSep™ PAN support using a Gardco wire rod #2. The coatings were dried in the vacuum oven at 80° C. for 15 minutes. The dried coatings were UV cured as previously described. Flux of water and CuSO₄ rejection through the membranes is shown in the table following:

| Crosslinker loading | Flux | CuSO₄ rejection |
|---|---|---|
| [wt. %] | [LMH/bar] | [%] |
| 5 | 9.1 | 77 |
| 15 | 9.4 | 75 |
| 25 | 6.6 | 82 |

PEG rejection as a function of molecular weight of the membranes is shown in the table below:

| Crosslinker | | | | | | | | | | | | | |
|---|---|---|---|---|---|---|---|---|---|---|---|---|---|
| loading [wt. %] | PEG Mw | 150 | 194 | 238 | 282 | 326 | 370 | 414 | 458 | 502 | 546 | 590 | 634 |
| 5 | Rejection [%] | 38 | 54 | 64 | 71 | 77 | 79 | 81 | 82 | 83 | 84 | 85 | 85 |
| 15 | Rejection [%] | 34 | 50 | 61 | 69 | 76 | 78 | 81 | 82 | 83 | 84 | 85 | 85 |
| 25 | Rejection [%] | 46 | 61 | 70 | 78 | 85 | 86 | 88 | 89 | 89 | 90 | 91 | 89 |

### Example 15: Crosslinking of Quaternized Hydroxy Functional Troger's Base Polymer Using a Diglycidyl Ether

Poly(ethylene glycol) diglycidyl ether (PEGDGE), Mw=500, (Sigma Aldrich) was dissolved in water to obtain a 1 wt. % solution. A solution of quaternized hydroxy functional quaternized Troger's base polymer was prepared as previously described. Benzyltriethylammonium chloride was dissolved in DI water to obtain a 0.5 wt. % solution. Solutions of hydroxy functional quaternized Troger's base polymer, PEGDGE and benzyltriethylammonium chloride were mixed to give 1 wt. % benzyltriethylammonium chloride relative to the Q-TB-OH polymer and 10 or 20 wt. % PEGDGE relative to the polymer. The blend solutions were heated at 80° C. for 4 hours under reflux to achieve a partial reaction (B-stage) in the solution. Resulting B-staged solutions were coated on SolSep™ PAN support using a Gardco wire rod #2, and the coatings were cured at 80° C. under vacuum.

What is claimed is:

1. A composite membrane comprising a porous support and a thin film layer comprising a reaction product of: i) a polymer comprising a sub-unit comprising a Troger's base moiety represented by Formula I: 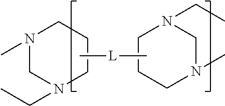
wherein L comprises an arylene group substituted with at least one carboxylic acid or a corresponding salt or ester group, or a hydroxyl; and ii) a crosslinking agent selected from at least one of: a) a multifunctional epoxy compound and b) a multifunctional azide compound.

2. The membrane of claim 1 wherein L comprises a fused ring structure including from 1 to 4 rings including at least one aromatic ring.

3. The membrane of claim 1 wherein L is selected from: phenylene, biphenylene, naphthalene and spirobisindane.

4. The membrane of claim 1 wherein the polymer comprises a repeating unit represented by at least one of the following formulae along with their corresponding regioisomers: 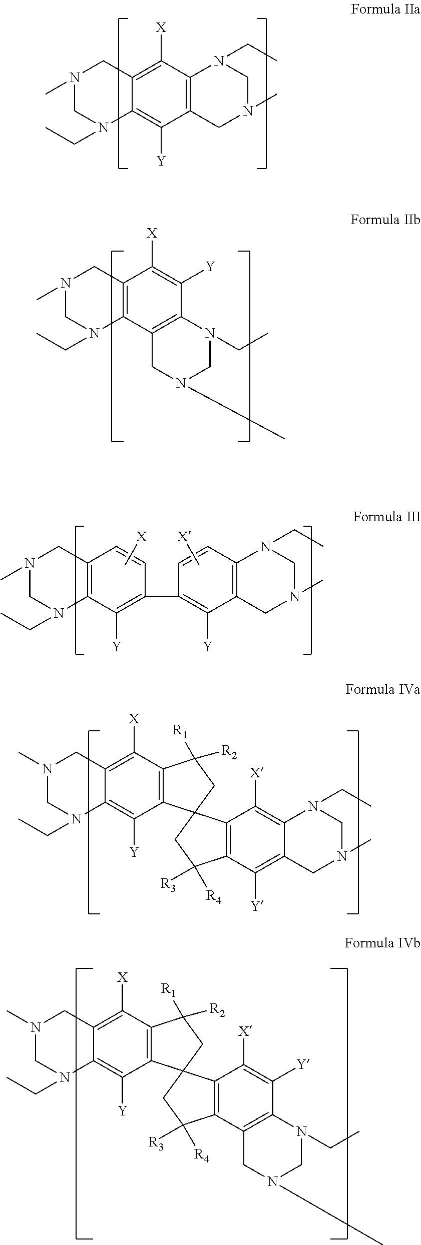 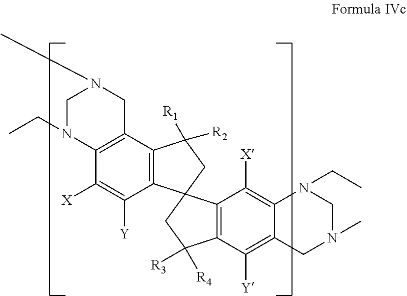
wherein X, Y, X′, and Y′ are independently selected from: carboxylic acid or a corresponding salt or ester, hydroxyl and hydrogen with the proviso that at least one of X, Y, X′, and Y′ is carboxylic acid or a corresponding salt or ester, or hydroxyl; and R₁, R₂, R₃, and R₄ are independently selected from: hydrogen, alkyl groups comprising from 1 to 6 carbon atoms, and R₁ and R₂ may collectively form a ketone group or a 9,9′-fluorene group, and R₃ and R₄ may collectively form a ketone group or a 9,9′-fluorene group.

5. The membrane of claim 1 wherein the crosslinking agent is represented by: 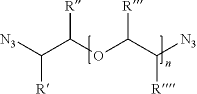
where each R′, R″, R′″ and R″″ are independently selected from hydrogen and alkyl and n is an integer from 1 to 50.

6. The membrane of claim 1 wherein the crosslinking agent is represented by: 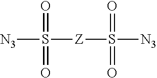
wherein Z is selected from an arylene group comprising from 1 to 3 aromatic rings.

7. The membrane of claim 1 wherein the crosslinking agent is represented by:

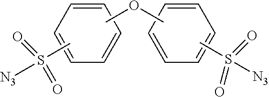

8. The membrane of claim 1 wherein the crosslinking agent is represented by: 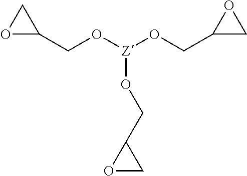
wherein Z′ is an arylene group comprising from 1 to 3 aromatic rings.

9. The membrane of claim 1 wherein the crosslinking agent is represented by: 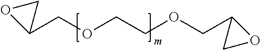
wherein m is an integer from 1 to 50.

10. The membrane of claim 1 wherein the crosslinking agent is represented by: [chemical structure]
